(19) United States
(12) Patent Application Publication
(10) Pub. No.: US 2024/0391647 A1
(43) Pub. Date: Nov. 28, 2024

(54) A STOPPER FOR CONTAINER

(71) Applicant: DSIGNTANK, SL, Barcelona (ES)

(72) Inventor: Jokin ARREGUI LETAMENDI, Barcelona (ES)

(73) Assignee: DSIGNTANK, SL, Barcelona (ES)

(21) Appl. No.: 18/684,502

(22) PCT Filed: Aug. 11, 2022
(86) PCT No.: PCT/EP2022/072521

§ 371 Date: Feb. 16, 2024

(30) Foreign Application Priority Data
Aug. 18, 2021 (ES) U202131684

(51) Int. Cl. B65D 39/00; B29C 45/00; B29C 45/72; B29K 21/00; B29K 105/00; B29K 105/16; B29K 507/04; B29L 31/56; B65D 65/46; C08K 3/04; C08L 67/04

(52) U.S. Cl. CPC B65D 39/0017; B29C 45/0001; B29C 45/0013; B29C 45/72; B65D 65/466; C08K 3/04; C08L 67/04; B29K 2021/003; B29K 2105/0032; B29K 2105/16; B29K 2105/162; B29K 2507/04; B29K 2905/12; B29K 2995/006; B29K 2995/0063; B29K 2995/0094; B29L 2031/565; C08K 2201/005; C08K 2201/018; C08L 2201/06; C08L 2205/20; C08L 2207/04

(57) ABSTRACT

The present invention relates to a stopper made entirely or at least in part of plastic material, wherein the plastic material is a thermoplastic elastomeric polymer and includes a dispersion of activated carbon particles. The present invention also relates to a method to manufacture a stopper for a container by means of injection molding comprising: heating granules or pellets of plastic material until the granules or pellets become soft and flexible; adding activated carbon particles to the soft and flexible granules or pellets of plastic material; injecting the softened plastic into a mold, thereby obtaining a desired shape for the stopper; leaving the plastic material to cool until hardening; and opening the mold and removing the stopper.

### TECHNICAL FIELD

The present invention relates to a stopper for a container where the entire body of the stopper or a part of it is made of a plastic material and activated carbon.

### BACKGROUND ART

The use of cork stoppers to close the mouth of bottles containing wine or other alcoholic beverages having similar characteristics is known today. Cork is used for esthetic and functional reasons. For example, natural cork stoppers are used in wines or other beverages, such as sparkling wines, cava, or champagne, which must be kept in bottle for a long time, because they allow the slight oxidation of the wine or sparkling wine as they are not completely airtight; these stoppers are particularly relevant in vintage wines. Agglomerated cork stoppers, manufactured from cork granules, which are an inexpensive raw material, are also used, where these stoppers are more suitable for young wines which will not be kept in bottle for too long because, unlike natural cork, they do not allow said exchange of oxygen.

However, some cork stoppers may cause a sensory defect in products which come into contact with same, particularly due to the organochlorinated residual chemical compounds used as microbial agents in the treatment of wood-derived products.

Alternatively, the use of stoppers made from a synthetic material for closing bottles has been known for years. The process of manufacturing these plastic stoppers also presents advantages in terms of raw material and manufacturing costs, as it enables large-scale production in a shorter time.

Document ES2257128A1 discloses a plastic material composition for stoppers which is formed by a mixture of styrene/ethylene-butylene/styrene, medical-grade white oil, polypropylene, foaming agent, and additives.

Document EP1705127A2 describes a synthetic stopper for bottles, characterized in that it comprises two portions of synthetic material having differentiated deformation capacity, a first plastic portion and a second elastic portion.

The present invention proposes a solution for improving the inherent properties of a stopper made of a plastic material, among other advantages.

### BRIEF DESCRIPTION OF THE INVENTION

The present invention relates to a stopper for a container made entirely or at least in part of a plastic material.

As known in the art, said stopper for a container or a part thereof is made of a composition comprising a plastic material.

However, differently to what is known in the art, it is proposed for this plastic material to further include a dispersion of activated carbon particles mixed with the plastic material and for the plastic material according to the present invention to be from the group of thermoplastic elastomeric polymers such as, for example, mixtures of vulcanized rubber, ethyl-vinyl-acetate copolymers, styrene-butadiene-styrene copolymers, thermoplastic polyurethane (TPU), polyester-ether copolymer, polyamide-polyether copolymers, polyester, and/or combinations thereof.

In another embodiment, the plastic material in the present invention from the group of thermoplastic elastomeric polymers is biodegradable; preferably, the plastic material is a bioplastic.

As known in the art, a bioplastic is a natural biodegradable plastic which is produced by a living organism, obtained from renewable energy sources, and not requiring catalysts for the biodegradation thereof. In the present invention, bioplastics are understood to mean those polymers which undergo biodegradation at a rate of up to 90% by weight in six months, i.e., those in which 90% of their mass by weight is transformed into carbon dioxide, water, and biomass in 180 days.

Preferably, the plastic material according to the present invention comprises a biodegradable bioplastic originating from plants or fermentation. Furthermore, in another embodiment, the plastic material consists of a mixture of biodegradable bioplastics originating from plants or fermentation. Preferably, the biodegradable bioplastic according to the present invention is obtained from corn, sugarcane, beetroot, soybean, cellulose, vegetable oil, plants, or algae.

In particular, the biodegradable bioplastic is selected from the group consisting of polylactic acid, pullulan, gum, latex, polycaprolactone, and/or combinations thereof. Preferably, the biodegradable bioplastic is polylactic acid (PLA). These biodegradable bioplastics are also thermoplastic elastomeric polymers, as described above.

Preferably, the density of the plastic material is comprised between 0.01 and 15 g/cm³, more preferably between 0.5 and 5 g/cm³, more preferably between 1.5 and 4 g/cm³.

Alternatively, the plastic material can be replaced by cork, either natural cork or agglomerated granulate cork.

As indicated above, the stopper for a container or a part thereof according to the present invention includes activated carbon particles dispersed in the plastic material constituting the whole stopper or a part thereof.

Activated carbon has known filtering properties, so the resulting stopper or a part thereof will present filtering properties, particularly with respect to a gas that could pass through the stopper, or with respect to any substance or product which comes into contact with the mentioned stopper or part of a stopper.

Activated carbon also provides a characteristic black color to any product containing it, allowing users to readily identify a plastic stopper or part of a plastic stopper with improved properties as the one proposed by its color.

Preferably, the activated carbon particles are or include microparticles or nanoparticles. The smaller the size of the activated carbon particles, the larger their effective surface are, and therefore the better their filtering capacity. In a preferred embodiment, the activated carbon present in the stopper or part of a stopper is powdered activated carbon. Despite the foregoing, it is envisaged for the activated carbon particles to also include granular activated carbon, with particles having a larger size of up to 5 mm in diameter, for example, which are dispersed in the plastic material and immediately visible. Therefore, the activated carbon particles may have a size comprised between 100 nm and 5 mm, preferably between 0.5 microns and 0.5 mm, preferably between 0.5 microns and 100 microns.

It is also proposed for the plastic material to include a proportion of activated carbon particles sufficient to provide the plastic product a dark color with a mean color brightness value substantially lower than the mean color brightness value of an equivalent product lacking activated carbon, facilitating the clear identification thereof by a user. A user could thus identify a container provided with a stopper or part of the stopper providing all the aforementioned advantages, with the color therefore being a visual indicator differentiating the stopper according to the invention from other stoppers. Furthermore, the inclusion of activated carbon particles according to the present invention does not necessarily mean the attainment of a stopper or part of a stopper with a homogenous color; depending on the particle size of the activated carbon, the user can identify with the naked eye the particles thereof which are embedded in the stopper or part of a stopper.

Likewise, in the stopper for a container according to the present invention, the color is provided exclusively by the activated carbon particles included in the plastic material. The thermoplastic elastomeric material according to the present invention does not comprise any dye, so the activated carbon will be that which provides the (dark) color to the stopper or part of a stopper.

Preferably, the dark color of the stopper for a container or part of a stopper for a container will have a mean color brightness value equal to or less than 50%, or preferably equal to or less than 40%, whereas an equivalent product without activated carbon typically has a mean color brightness value equal to or greater than 70%.

Color brightness is understood as the capacity of a color to reflect the white light striking it, with colors having a brightness value closer to 0% being darker.

The stopper for a container or part of a stopper for a container according to the present invention will preferably constitute at least one part of the stopper intended for being in contact with the content of the container when the container is closed with said stopper, and/or constitute at least one part of the stopper intended for being visible and/or accessible from outside the container when the container is closed with said stopper, and/or for forming a leak-tight sealing ring between the stopper and the container.

The outer portion of the stopper, besides allowing the visual recognition thereof, also allows filtering air going through the stopper by means of the activated carbon particles. This effect is also provided by the use of the plastic material with activated carbon as a leak-tight sealing ring.

It is also contemplated for the stopper or part of the stopper to include differentiated portions, or differentiated portions adhered to one another, wherein the portions are differentiated as a result of having different concentrations of activated carbon particles, different grain size distributions of activated carbon particles, and/or different compositions of plastic material. This differentiation can alter the properties of each of the portions or impart a different dark color to said portions.

The proportion of activated carbon will be between 0.1% and 50% of the dry weight of the stopper or part of the stopper for a container, preferably between 0.1% and 40%, more preferably between 0.1% and 30%. Even more preferably, the activated carbon will be between 0.1% and 10% of the dry weight of the stopper or part of the stopper for a container. When the weight of activated carbon is in the range of between 0.1% and 10%, the elasticity in the material and the stopper or part of the stopper for a container has been proven to be optimal for its intended function. Preferably, the activated carbon will be between 0.5% and 10% of the dry weight of the stopper or part of a stopper for a container, preferably between 1% and 10%, preferably between 1% and 5%, more preferably between 2% and 5%.

Furthermore, it is also proposed for the plastic material to also include or comprise a dispersion of plastic microbeads. Plastic microbeads are defined as solid plastic particles, generally of up to one millimeter in length/diameter. Preferably, the plastic microbeads according to the present invention have a particle size ranging from 10 micrometers to 1 mm.

Likewise, the plastic microbeads are usually obtained from materials such as polyethylene (PE), polyethylene terephthalate (PET), nylon or polyamide (PA), polypropylene (PP), and poly(methyl methacrylate) (PMMA). The most widely used materials for plastic microbeads according to the present invention are polyethylene or other petrochemical plastics such as polypropylene and polystyrene.

The low melting temperature and quick phase transitions of the polymers forming the plastic microbeads make them particularly suitable for creating porous structures, in ceramic and in other materials, such as in the case of the thermoplastic elastomeric polymer of the stopper for a container or of part of a stopper for a container according to the present invention.

The microbeads, being of a plastic material, provide rigidity to the stopper for a container or part of a stopper for a container defined in the present invention.

Likewise, the plastic microbeads according to the present invention can impart color to the stopper or part of a stopper if they comprise a dye. Alternatively, the plastic microbeads according to the present invention may not comprise any dye, so the color of the stopper for a container or part of a stopper for a container would be determined by the activated carbon dispersed in the plastic material

Preferably, the plastic microbeads are between 1% and 20% of the dry weight of the stopper or part of a stopper for a container, more preferably between 5% and 15%.

A method of manufacturing the mentioned stopper for a container or part of a stopper for a container by means of injection molding, is also envisaged, said method comprising the following steps:
heating granules (or pellets) of plastic material, preferably in a metal hopper, until said granules become soft and flexible;
adding activated carbon particles to the soft and flexible granules of plastic material;
injecting the softened plastic into a mold, preferably a steel mold, thereby obtaining the desired shape for the stopper or part of a stopper;
leaving the plastic material to cool until hardening; and.
opening the mold and removing the stopper or part of a stopper.

If several stoppers are manufactured together in the same mold, they are carefully separated from one another and prepared for subsequent processing (for example, a subsequent sealing step).

Optionally, in an embodiment of the method, adding plastic microbeads sequentially or together with the activated carbon particles is envisaged.

Other features of the invention will become apparent in the following detailed description of an embodiment.

### BRIEF DESCRIPTION OF THE FIGURES

The foregoing and other advantages and features will be better understood based on the following detailed description of an embodiment in reference to the attached drawings which should be interpreted in an illustrative and non-limiting manner, in which:

FIG. 1 shows a detail of a stopper for a container including activated carbon particles of several sizes, for example particles larger than 1 mm;

FIGS. 2 to 5 show four examples of stoppers including the stopper for a container, with the first two examples (FIGS. 2 and 3) being stoppers formed entirely by the plastic product material and activated carbon, the third example (FIG. 4) showing a large-headed stopper formed only partially by said plastic product material and activated carbon, and the fourth example (FIG. 5) showing a stopper in which the plastic product material and activated carbon only form a sealing ring. The activated carbon present in the plastic stopper is illustrated in FIGS. 2 to 5 by means of a (lined) fill pattern.

### DETAILED DESCRIPTION OF AN EMBODIMENT

The attached figures show illustrative, non-limiting embodiments of the present invention.

According to a first embodiment of the invention, a stopper for bottles containing wine, cava, champagne, or another beverage which is formed, at least in part, by a plastic material including activated carbon particles dispersed in said plastic material, is proposed.

All the activated carbon particles contained in the stopper or part of a stopper may have a homogeneous or heterogeneous grain size distribution. For example, the mixing of particles equal to or larger than 1 mm with microparticles and/or with activated carbon nanoparticles is envisaged.

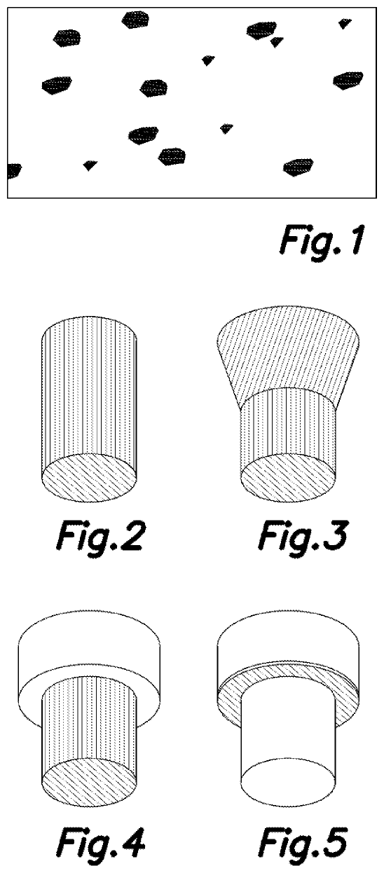

The activated carbon will be present in the product in a sufficient proportion so that the color brightness of the resulting plastic product is equal to or less than 50%, or even 40%, providing plastic products with a range of colors ranging from dark brown to black. Furthermore, a user will be able to perceive, with the naked eye, the activated carbon, particularly when the particle size is more than 1 mm, so the coloration of the stopper is not homogeneous in a preferred embodiment, as shown in FIG. 1.

The stopper according to the present invention can be formed completely by the mentioned plastic product, for example forming a stopper for wine, sparkling wine, such as cava or champagne, or a distillate or spirit, such as those schematically shown in FIGS. 2 and 3. Other possibilities envisaged in the present invention, although not shown in the figures, include a stopper for a container or part of a stopper for a container which contains cosmetic products, in which the preservation and stability of the product contained therein are critical and a stopper or part of a stopper according to the present invention solves the problem relating to the degradation and/or oxidation of these cosmetic products.

Alternatively, only a part of the stopper will be formed by the proposed plastic material and activated carbon. For example, FIG. 4 shows a large-headed stopper in which only the portion intended to be inserted into the neck of the bottle is formed by the proposed plastic material, with the head of the stopper being formed by another material. Said another material can be, for example, natural cork, agglomerated granulate cork, wood, glass, or even a plastic material without activated carbon, or with a different proportion or grain size distribution of activated carbon.

It is also proposed for the stopper to be able to include, in the different portions thereof, the proposed plastic material with activated carbon with different concentrations of activated carbon. FIG. 5 shows another embodiment whereby the stopper only includes the proposed plastic material with activated carbon in a sealing ring intended for being pressed against the mouth of a container closed by said stopper. Said sealing ring will filter the gas passing therethrough.

It will be understood that the different parts forming the invention described in an embodiment can be freely combined with the parts described in other different embodiments, although said combination has not been explicitly described, provided that the result of said combination is within the scope of the claims and provided that there is no incompatibility in the combination.

What is claimed is:

1. A stopper for a container made entirely or at least in part of plastic material, wherein the plastic material is a thermoplastic elastomeric polymer and includes a dispersion of activated carbon particles and a dispersion of plastic microbeads.

2. (canceled)

3. The stopper for a container according to claim 1, wherein the thermoplastic elastomeric polymer is selected from the group consisting of mixtures of vulcanized rubber, ethyl-vinyl-acetate copolymers, styrene-butadiene-styrene copolymers, thermoplastic polyurethane (TPU), polyester-ether copolymer, polyamide-polyether copolymers, polyester, and/or combinations thereof.

4. The stopper for a container according to claim 1, wherein the thermoplastic elastomeric polymer is biodegradable.

5. The stopper for a container according to claim 1, wherein the thermoplastic elastomeric polymer is a bioplastic.

6. The stopper for a container according to claim 1, wherein the thermoplastic elastomeric polymer degrades at a rate of 90% by weight in 6 months.

7. The stopper for a container according to claim 1, wherein the thermoplastic elastomeric polymer comprises a biodegradable bioplastic originating from plants or fermentation.

8. The stopper for a container according to claim 7, wherein the thermoplastic elastomeric polymer consists of a biodegradable bioplastic originating from plants or fermentation or of mixtures of biodegradable bioplastics originating from plants or fermentation.

9. The stopper for a container according to claim 7, wherein the biodegradable bioplastic is selected from the group consisting of polylactic acid, gum, latex, and/or combinations thereof.

10. The stopper for a container according to claim 1, wherein the density of the plastic material is comprised between 0.5 and 5 g/cm³.

11. The stopper for a container according to claim 1, wherein the activated carbon is between 1% and 10% of the dry weight of the stopper for a container.

12. The stopper for a container according to claim 1, wherein the activated carbon particles are powdered activated carbon or granular activated carbon.

13. The stopper for a container according to claim 1, wherein the activated carbon particles have a size comprised between 100 nm and 5 mm.

14. The stopper for a container according to claim 1, wherein the activated carbon particles have a size comprised between 0.5 and 100 microns.

15. The stopper for a container according to claim 1, wherein the activated carbon particles are in a proportion that provides the stopper for a container a dark color with a mean color brightness value substantially lower than the mean color brightness value of an equivalent product lacking activated carbon.

16. Method to manufacture a stopper for a container by means of injection molding, comprising the following steps:
heating granules or pellets of plastic material until the granules or pellets become soft and flexible;
adding activated carbon particles to the soft and flexible granules or pellets of plastic material;
injecting the softened plastic into a mold, thereby obtaining a desired shape for the stopper;
leaving the plastic material to cool until hardening; and
opening the mold and removing the stopper.

17. The method according to claim 16, wherein the heating of granules or pellets of plastic material are heated in a metal hopper.

18. The method according to claim 16, wherein the mold is a stool mold.

19. The method according to claim 16, wherein plastic microbeads are added together with the activated carbon particles.
